(19) United States
(12) Patent Application Publication
(10) Pub. No.: US 2022/0238888 A1
(43) Pub. Date: Jul. 28, 2022

(54) ELECTRODE AND SECONDARY BATTERY CELL WITH SUCH AN ELECTRODE

(71) Applicant: VOLKSWAGEN AKTIENGESELLSCHAFT, Wolfsburg (DE)

(72) Inventors: Jessica HÜSKER, Braunschweig (DE); Martina DIENER, Wendeburg (DE); Zhihang YU, Salzgitte (DE)

(73) Assignee: VOLKSWAGEN AKTIENGESELLSCHAFT, Wolfsburg (DE)

(21) Appl. No.: 17/583,973

(22) Filed: Jan. 25, 2022

(30) Foreign Application Priority Data
Jan. 27, 2021 (DE) DE10 2021200736.8

(51) Int. Cl. H01M 4/75; H01M 10/0525; H01M 4/66; B60L 50/64; H01M 10/625; H01M 10/654

(52) U.S. Cl. CPC H01M 4/75; H01M 10/0525; H01M 4/661; B60L 53/11; H01M 10/625; H01M 10/654; H01M 2220/20; B60L 50/64

(57) ABSTRACT

An electrode for a secondary battery cell has a foil-like electrode main body, the electrode main body including a collector section as a current collector and a contact section for electrically contacting a cell tab, the collector section and the contact section having different electrical conductivities and/or different thermal conductivities. A secondary battery cell has such an electrode, and an electrically powered motor vehicle may have a traction battery with such a secondary battery cell.

### CROSS REFERENCE TO RELATED APPLICATION

This application claims priority from German Patent Application No. 10 2021 200 736.8, filed Jan. 27, 2021, which is incorporated by reference in its entirety.

### FIELD OF THE INVENTION

The invention relates to an electrode for a secondary battery cell, the electrode having an electrode main body including a collector section and a contact section. The invention also relates to a secondary battery cell with such an electrode and to an electrically powered motor vehicle whose traction battery has such a secondary battery cell.

### BACKGROUND OF THE INVENTION

An electrically powered motor vehicle typically has a traction battery (high-voltage battery, HV battery) that powers an electric motor to drive the motor vehicle. In this context, an electrically powered motor vehicle is understood to be in particular an electric vehicle that stores the energy required for propulsion solely in the traction battery (BEV, battery-electric vehicle), an electric vehicle with a range extender (REEV, range-extended electric vehicle), a hybrid vehicle (HEV, hybrid electric vehicle), a plug-in hybrid vehicle (PHEV, plug-in hybrid electric vehicle) and/or a fuel cell vehicle (FCEV, fuel cell electric vehicle) that stores the electrical energy generated by a fuel cell temporarily in the traction battery.

Such a traction battery includes a number of secondary battery cells (referred to in short as battery cells), which are combined into battery modules (cell modules), for example. The battery cells and, as the case may be, the battery modules are interconnected in series and/or in parallel so that the traction battery can provide a sufficiently high current and a sufficiently high voltage to an electric motor provided for driving the motor vehicle. Typically, the traction battery is configured as a lithium-ion battery, and its secondary battery cells as lithium-ion battery cells.

Each of the battery cells includes at least one anode and at least one cathode. These electrodes are each formed by a carrier foil, which is typically a metal foil, and which is coated with an active material within a so-called collector section. The carrier foil further includes an uncoated contact section, which is referred to as contact tab, and via which the electrode can be electrically connected to a cell tab.

For maximum user convenience, it is desirable that the traction battery; i.e., its battery cells, can be charged as quickly as possible. During charging, the current flows through the contact tabs into the collector section. In order to avoid damage to the traction battery and its battery cells, a maximum achievable charging rate of the charging process must be limited due to heat generation and/or due to the ohmic resistance of the battery cells, in particular of the contact tab and the collector section.

### SUMMARY OF THE INVENTION

It is an object of the invention to provide an especially suitable electrode for a secondary battery cell, for example for a lithium-ion battery cell. In particular, this electrode is intended to enable as fast a charging process as possible. A further object is to provide such a secondary battery cell and an electrically powered motor vehicle whose traction battery includes at least one such secondary battery cell.

With regard to the electrode, the object is achieved in accordance with the invention by the features of claim 1. With regard to the secondary battery cell, the object is achieved in accordance with the invention by the features of claim 9, and with regard to the electrically powered motor vehicle by the features of claim 10. Advantageous embodiments and refinements are the subject matter of the dependent claims. The explanations given with respect to the electrode also apply analogously to the secondary battery cell and to the electrically powered motor vehicle and vice versa.

For the above purposes, the electrode has a main body which, in turn, includes a collector section and a contact section. The collector section serves as a current collector. The contact section is provided and adapted to electrically contact a cell tab (also called just “tab”) of a battery cell containing the electrode, the cell tab allowing electric current to be conducted to the electrode or away from the electrode. In some battery cell designs, for example in a cylindrical or a prismatic battery cell, provision is made for the contact section to electrically contact a housing part of the battery cell containing the electrode. In this case, the contact section is provided and adapted to electrically contact the housing part.

The electrode main body is preferably foil-like, and in particular in sheet or strip form. For example, the electrode main body is formed using a foil or using a plurality of foils. In this case, the electrode main body is also referred to as carrier foil(s). Alternatively or additionally, the contact section and/or the collector section are/is formed using a porous structure based on a preferably woven or spun net. Addition or alternatively, the contact section and/or the collector section are/is provided with cutouts or, for example punched, holes.

The collector section is either formed integrally (monolithically); i.e., continuously, with the contact section, or alternatively, the collector section and the contact section are separate components of the electrode main body, which are joined and suitably electrically connected to each other. Conveniently, the contact section is disposed at the edge of the collector section and/or protrudes laterally beyond the collector section in a plane defined by it.

The collector section and the contact section have different electrical conductivities and/or different thermal conductivities. In other words, the thermal conductivity of the collector section is different from the thermal conductivity of the contact section, and/or the electrical conductivity of the collector section is different from the electrical conductivity of the contact section. In particular, the value of the electrical conductivity and/or the value of the thermal conductivity of the contact section are/is not equal to the respective value(s) of the electrical conductivity and the thermal conductivity of the collector section.

With the inventive electrode, especially when compared to electrodes whose main body is formed of a single continuous foil, the electrical conductivity and/or the thermal conductivity of the contact section and of the collector section can be selected according to different requirements on the electrical and/or thermal conductivities of these sections, and conveniently are selected and realized in this way. This makes it easier to meet locally different requirements. For example, the electrical and thermal conductivity of the contact section is greater than the electrical and thermal conductivity of the collector section, so that heat dissipation via the contact sections is improved and/or a higher charging or discharging current can be achieved.

The electrode is suitably provided for a secondary battery cell, for example for a lithium-ion battery cell.

In accordance with a suitable embodiment, for purposes of designing the collector section and the contact section differently in terms of their electrical and/or thermal conductivity, the collector section and the contact section have different thicknesses. In other words, the spatial extent of the contact section perpendicular to a plane defined by the electrode main body is different from; i.e. greater or less than, the spatial extent of the collector section in this direction. For example, the electrode main body is in the form of a single metal foil, during the manufacture of which the contact section was rolled under less pressure than the collector section.

Additionally or alternatively, in accordance with a practical embodiment, the collector section and the contact section are formed of different materials to achieve the purpose of designing the collector section and the contact section differently in terms of their electrical and/or thermal conductivity. Thus, in particular, the contact section is formed of a first material and the collector section is formed of a second material, the first material and the second material being different, and the electrical and/or thermal conductivity of the first material being different from the electrical and/or thermal conductivity of the second material.

In accordance with a practical embodiment, the collector section is formed of a polymer film coated with a metal. Alternatively, the collector section is formed of a carbon foil coated with the metal. The contact section is formed using a metal foil, for example. Advantageously, the weight of a metal-coated polymer film or carbon foil is less than the weight of a metal foil of the same size. Consequently, the weight of the entire electrode is reduced, and the gravimetric energy density of a battery cell containing the electrode is increased.

Additionally or alternatively, the collector section and the contact section differ in other physical properties, such as their surface structure, their roughness and/or their porosity. By using different surface structures, the surface structure of the collector section can be provided and adapted for a relatively reliable adhesion of the coating of active material, while the surface structure of the contact section can be provided and adapted for a relatively reliable electrical and/or mechanical contact with the tab or with the housing.

In accordance with a practical embodiment, the collector section is coated with an active material. Preferably, the collector section is coated on both sides with the active material. If the electrode is intended as an anode, the collector section is formed, for example, by a copper foil, with graphite, graphene, lithium titanate (LTO), or so-called hard carbon, soft carbon and/or carbon nanotubes being used as the (anode) active material. Alternatively, the collector section is provided with silicon, with a silicon-based anode material, with lithium as an active material. Alternatively or additionally, the anode is provided with another material known in the art as an active material for an anode. If the electrode is intended as a cathode, the collector section is formed, for example, by an aluminum foil, with a lithium-nickel-cobalt- aluminum oxide (NCA), a lithium-iron phosphate (LFP), a lithium-nickel-manganese-cobalt oxide (NMC), sulfur, a sulfur compound, lithium-manganese oxide (LMO), lithium-manganese-nickel oxide (LMNO), lithium-cobalt oxide (LCO), LiFeSO₄F, LiTiS₂ or any other material known in the art as active material for a cathode being usable as active material. Conveniently, the layer containing the active material further includes a binder as well as a conducting agent and/or additional conducting additives, such as carbon black, graphene, carbon nanotubes, or carbon nanofibers.

Alternatively, the collector section is not coated with an active material, especially if the electrode is intended for use in a solid-state battery cell (solid electrolyte battery cell). In this case, the lithium deposits directly on the collector section during operation of the solid-state battery cell. In this connection, the collector section has, for example, a surface structure that promotes such deposition. For example, the surface structure serves to increase the surface area of the collector section.

In an advantageous refinement, the collector section has a first portion and a second portion, the first portion and the second portion being different in terms of their electrical and/or thermal conductivity. Conveniently, the two portions are disposed adjacent each other in the plane defined by the collector section. The two portions have, for example, different thicknesses relative to each other; i.e., different spatial extents in a direction perpendicular to the plane defined by the collector section, and/or different materials. For example, the first portion surrounds the second portion like a frame, or is disposed at the periphery of the second portion. This allows the thermal and electrical conductivity properties of the collector section to be further adjusted or adapted. For example, the first portion has a higher thermal and electrical conductivity than the second portion, with the first portion adjoining the contact section, so that relatively good heat dissipation from the electrode is achieved. To this end, for example, the first portion is formed using a metal foil coated with active material, the metal foil in the second portion being thinner.

In an advantageous embodiment, the electrode main body has a plurality of contact sections; i.e., more than one contact section. In other words, the electrode main body includes the contact section and further contact sections. In this case, the contact sections are in particular disposed on a common edge or side of the collector section and are, for example, identical in design. Alternatively, however, the contact sections may differ in their electrical and/or thermal conductivities. For this purpose, the contact sections have, for example, different thicknesses and/or are formed of different materials.

Especially if the electrode is intended to form a jelly roll, it has a strip shape; i.e., an elongated shape. In this case, the contact sections are preferably arranged at even or uneven intervals along the (relatively long) longitudinal side of the collector section. By using a plurality of contact sections at an edge of the collector section, the total resistance of the electrode is advantageously reduced.

Alternatively, in an advantageous embodiment, the contact section extends along the entire width or along the entire length of the collector section. In comparison to electrodes where the contact section extends only along a relatively small portion of the length or width, an average distance traveled by an electron from the collector section to the contact section is reduced, which is accompanied by a reduction in the electrical resistance of the electrode.

Another aspect of the invention relates to a (secondary) battery cell containing an electrode in any of the variants described above. The battery cell is designed, for example, as a lithium-ion battery cell and may be configured as a pouch cell, as a round cell, or as a prismatic cell.

Preferably, each of the electrodes of the battery cell; i.e. all of its anodes and all of its cathodes, are configured in any of the variants described above. In particular, each of the electrodes of the battery cell has a collector section and a contact section, the collector section and the contact section having different electrical conductivities and/or different thermal conductivities.

Furthermore, the electrode main bodies of the cathodes may be different from one another. Additionally or alternatively, the electrode main bodies of the anodes may be different from one another. For example, the battery cell has conventional electrodes in addition to the electrode or electrodes in any of the variants described above.

Another aspect of the invention relates to an electrically powered motor vehicle having a traction battery. This traction battery has at least one (secondary) battery cell in any of the variants illustrated above.

### BRIEF DESCRIPTION OF THE DRAWINGS

Exemplary embodiments of the invention are described in more detail below with reference to the drawings, in which:

FIG. 1 schematically shows an electrically powered motor vehicle whose traction battery (battery system) has a number of battery modules, the battery modules in turn including a number of secondary battery cells configured as lithium-ion battery cells;

FIG. 2a shows a schematic elevation view of a first variant of the electrode of one of the battery cells, the electrode having an electrode main body including a contact section and a collector section coated with active material;

FIG. 2b shows a schematic side view of the electrode of FIG. 2a, where the contact section has a greater thickness than the collector section;

FIG. 2c shows a schematic side view of the electrode in accordance with an alternative embodiment of the first variant, where the contact section has a smaller thickness than the collector section;

FIG. 3a shows a schematic side view of a second variant of the electrode, where the collector section thereof is formed using a polymer film or carbon foil provided with a metal layer;

FIG. 3b shows a schematic elevation view of an alternative embodiment of the second variant of the electrode, where the collector section has a first portion, which is formed using a metal foil, and a second portion, which is formed using a polymer film or carbon foil provided with a metal layer;

FIG. 3c shows the electrode of the alternative embodiment of the second variant in a schematic cross-sectional view taken in the plane IIIc indicated in FIG. 3b;

FIG. 4 shows a schematic elevation view of a third variant of the electrode, where the contact section extends along the entire width of the collector section; and

FIG. 5 shows a schematic elevation view of a fourth variant of the electrode, where the electrode is in strip form and has a plurality of contact sections at its longitudinal side.

Corresponding parts and quantities are given the same reference characters throughout the figures.

### DETAILED DESCRIPTION OF THE INVENTION

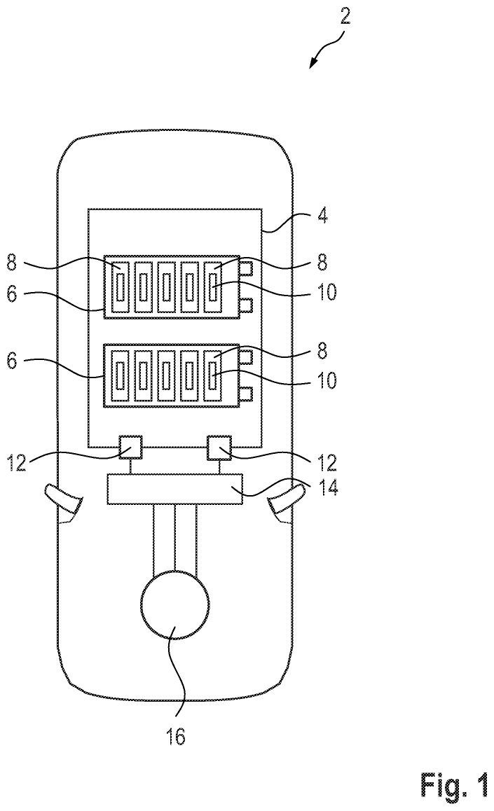

FIG. 1 shows a motor vehicle 2 having a traction battery 4. Traction battery 4 has a number of battery modules 6, also referred to as cell modules. For improved clarity, only two of the battery modules 6 are shown.

Each of the battery modules 6 in turn includes a number of secondary battery cells 8 configured as lithium-ion battery cells, five of which are shown for each battery module 6. In FIG. 1, the battery cells 8 are configured, by way of example, as pouch cells, with the battery cells 8 being electrically interconnected by means of their cell tabs 10. In particular, the battery cells 8 of each battery module 6 are interconnected in series and/or in parallel via their cell tabs 10 in a manner not specifically shown. Moreover, battery modules 6 are interconnected in series and/or in parallel in a manner not specifically shown and are electrically connected to battery terminals 12 for a load.

A load is connected to battery terminals 12 of traction battery 4, the load here being in the form of an inverter 14 of a drive train of motor vehicle 2 and an electric motor 16 connected thereto. Inverter 14 converts the DC current and DC voltage provided by traction battery 4 to an AC current and AC voltage suitable for operation of electric motor 16. In summary, the traction battery provides electrical energy for driving motor vehicle 2.

In alternatives not specifically described herein, battery cells 8 are formed as round cells or as prismatic cells.

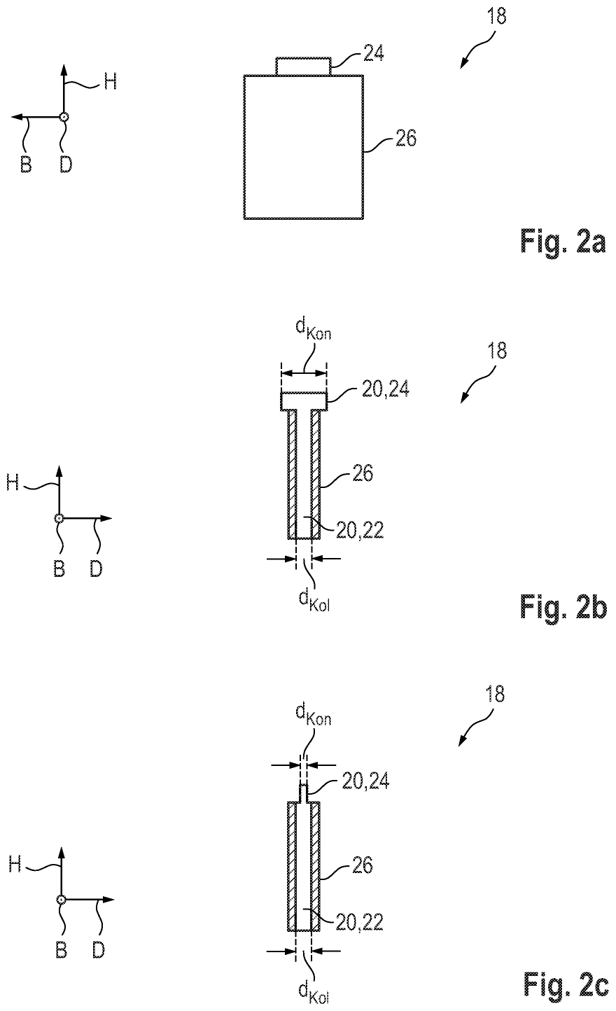

FIG. 2a shows a first variant of an electrode 18 of one of the battery cells 8. Electrode 18 includes a foil-like electrode main body 20, which is formed by a collector section 22 as a current collector and by a contact section 24. Contact section 24 serves for electrically contacting electrode 18 to cell tab 10 within battery cell 8, the cell tab 10 extending to the outside of the battery cell, where it is wired to a circuit.

In this first variant, electrode main body 20 is configured as a (single) metal foil. Consequently, contact section 24 and collector section 22 are formed monolithically; i.e. continuously with each other. Furthermore, electrode 18 includes active material, with which collector section 22 is coated on both sides. This coating of active material is denoted by reference numeral 26.

Electrode main body 20 defines a plane, with the main directions of extension being labeled B (for the width direction) and H (for the height direction) in the adjacent direction diagram. The direction perpendicular to this plane is denoted by reference numeral D (for the thickness direction). The specified directions apply analogously to the embodiments of FIGS. 2b through 4.

As can be seen in FIG. 2b, collector section 22 has a thickness d_{Kol} and the contact section has a thickness d_{Kon}, the thickness d_{Kon} of contact section 24 being greater than the thickness d_{Kol} of collector section 22. In other words, the spatial extent of contact section 24 in direction D is greater than the spatial extent of collector section 22 in this direction.

FIG. 2c illustrates an alternative embodiment of the electrode of the first variant. This alternative embodiment differs from the first variant only in that the thickness d_{Kol} of collector section 22 is greater than the thickness d_{Kon} of contact section 24.

In variants (not specifically described) of the electrodes 18 according to FIGS. 2a through 2c, collector section 22 is not provided with active material. In this case, the lithium deposits on the surface of collector section 22 during operation of the battery cell.

In summary, the contact section 24 and the collector section 22 according to the first variant and according to the alternative embodiment of the first variant have different thicknesses and, thus, different thermal and electrical conductivities.

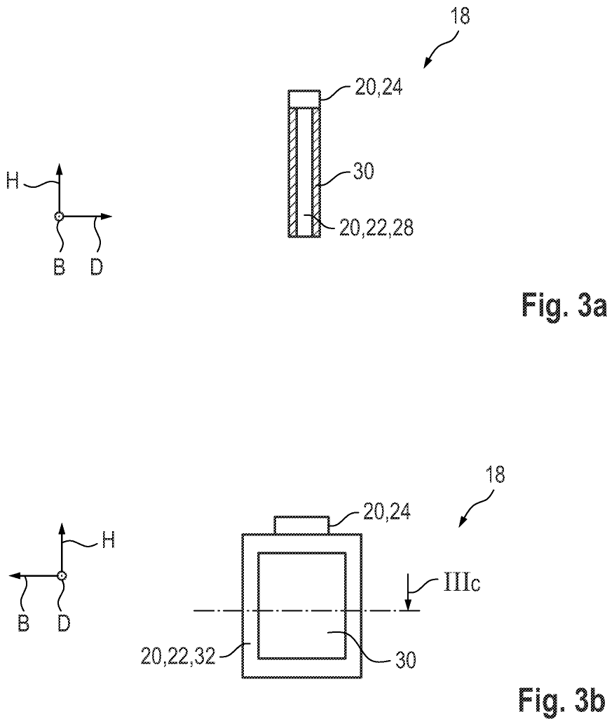

FIG. 3a shows a second variant of electrode 18. In the second variant, collector section 22 and contact section 24 are joined together and, thus, are not formed monolithically with each other. Contact section 24 is disposed at the edge, here at an edge of collector section 22 extending in direction B. Contact section 24 preferably takes the form of a metal foil as a first material M1. The collector section is formed by a polymer film or carbon foil 28 as a second material M2. The polymer film or carbon foil 28 is provided with a metal layer 30. Metal layer 30 is electrically connected to contact section 24. In summary, the material M1 of contact section 24 is different from the material M2 of collector section 22.

According to an alternative not specifically illustrated, collector section 24 and contact section 24 are formed of films or foils of different materials, in particular using different metal foils, with collector section 24 and contact section 24 being joined together. In this connection, collector section 24 is, for example, coated with active material.

FIGS. 3b and 3c show an alternative embodiment of the second variant of electrode 18. Here, collector section 22 includes two portions 32 and 34. First portion 32 is formed using a metal foil and is electrically connected to contact section 24. The first portion 32 and the contact section are, for example, formed in one piece, in other words monolithically. The second portion 34 of collector section 22 is formed using a polymer film or carbon foil 28 which is coated on both sides with a metal layer 30. For example, first portion 32 surrounds second portion 34 like a frame. Alternatively, first portion 32 is in the form of a strip extending between second portion 34 and contact section 24 along the edge of collector section 22 facing the contact section 24.

Thus, in summary, first portion 32 and second portion 34 are different in terms of their electrical and/or thermal conductivity.

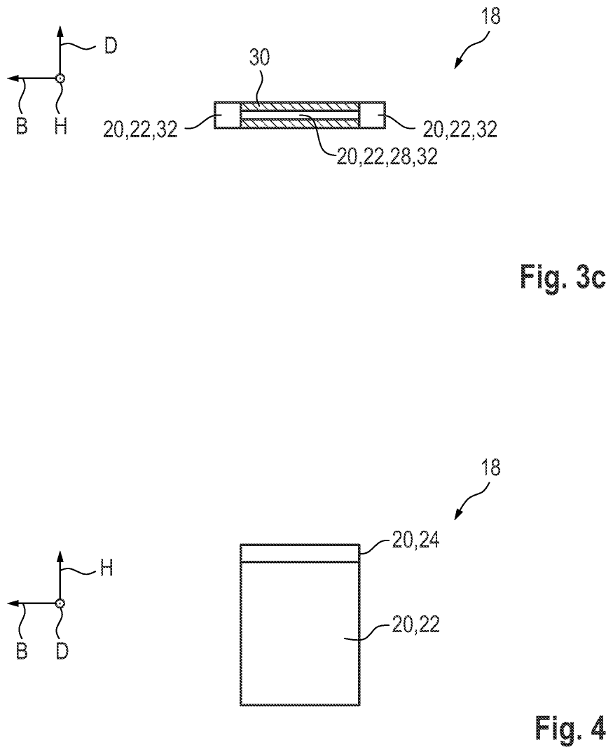

FIG. 4 shows a third variant of electrode 18. In this variant, contact portion 24 extends along the entire width of collector section 22; i.e., along the entire extent of collector section 22 in direction B. Analogously to the descriptions for FIGS. 2a through 2c, collector section 22 has a different thickness d_{Kol} than contact section 24, and/or, analogously to the descriptions for FIGS. 3a through 3c, contact section 24 is formed of a different material than collector section 22.

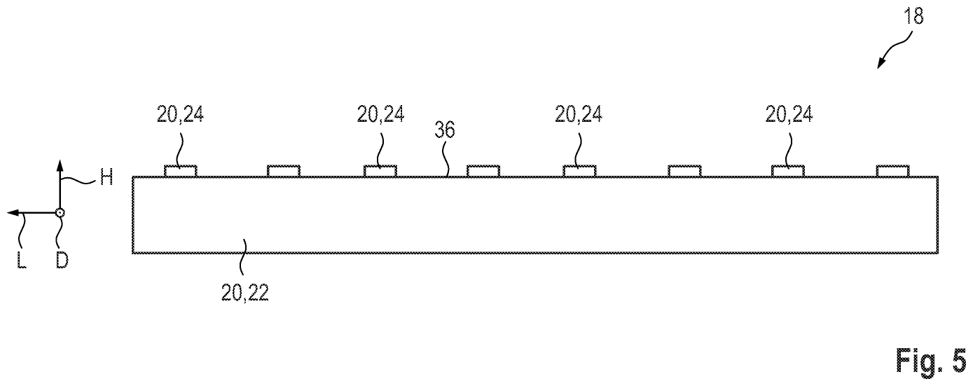

FIG. 5 shows a further, fourth variant of electrode 18, which is in strip form. Thus, the electrode defines a plane, with the main directions of extension of electrode 18 forming the longitudinal direction L and the height direction H. Moreover, the extent of electrode 18 in longitudinal direction L is relatively large compared to the extent in height direction H. Such a strip-shaped electrode 18 is intended, for example, to form a jelly roll or a flat roll, which are typically used in round cells or in prismatic cells.

Electrode main body 20 includes the collector section 22 and a plurality of contact sections 24 which here by way of example are disposed on a common longitudinal side 36 of collector section 22, which longitudinal side 36 extends in longitudinal direction L. The contact sections are, for example, identical in design. However, it is also possible that the contact sections may have different thicknesses and/or different extents in the longitudinal direction, and/or may be formed of different materials. The collector section is formed, for example, from a metal foil provided with active material or from a polymer film or carbon foil with a metal layer.

Possibly, at least one of the contact sections 24 has a different thickness d_{Kon} than collector section 22 and/or is formed of a different material than collector section 22.

In summary, in all of the variants and embodiments described above, the electrical conductivity σ_{Kol} of collector section 22 and/or the thermal conductivity λ_{Kol} of collector section 22 are/is different from the electrical conductivity σ_{Kol} of contact section 24 and the thermal conductivity λ_{Kol} of the contact section, respectively. In other words, the following holds:
σ_{Kol}≠_{Kon}, and/or
   λ_{Kol}≠λ_{Kon}.

This advantageously allows the electrical conductivities and/or the thermal conductivities of collector section 22 and of contact section 24 to be independently adapted to the particular requirements on the battery cell and its electrodes, in particular to different requirements on collector section 22 and contact section 24 in terms of their thermal and/or electrical conductivities.

The invention is not limited to the exemplary embodiments described above. Rather, other variants of the invention may also be derived therefrom by those skilled in the art without departing from the subject matter of the invention. Furthermore and in particular, all individual features described in connection with the exemplary embodiment may also be combined in other ways without departing from the subject matter of the invention.

### LIST OF REFERENCE CHARACTERS

2 electrically powered motor vehicle

4 traction battery

6 battery module

8 lithium-ion battery cell

10 cell tab

12 battery terminal

14 inverter

16 electric motor

18 electrode

20 electrode main body

22 collector section

24 contact section

26 coating of active material

28 polymer film or carbon foil

30 metal layer

32 first portion of the collector section

34 second portion of the collector section

36 longitudinal side

B width direction

D thickness direction

H height direction

L longitudinal direction

d_{Kol} thickness of the collector section

d_{Kon} thickness of the contact section

1. An electrode for a secondary battery cell, comprising:
a foil-like electrode main body,
wherein the electrode main body includes a collector section as a current collector and a contact section for electrically contacting a cell tab; and
wherein the collector section and the contact section have different electrical conductivities and/or different thermal conductivities.

2. The electrode as recited in claim 1, wherein the collector section is coated with active material.

3. The electrode as recited in claim 1, wherein the collector section and the contact section of the electrode main body have different thicknesses.

4. The electrode as recited in claim 1, wherein the collector section is formed of a first material, and the contact section is formed of a second material different from the first material.

5. The electrode as recited in claim 1, wherein the collector section is formed of a polymer film or from a carbon foil, and the polymer film or the carbon foil are coated with a metal.

6. The electrode as recited in claim 1, wherein the collector section has a first portion and a second portion, and wherein the first portion and the second portion have different electrical and/or thermal conductivity.

7. The electrode as recited in claim 1, wherein the electrode main body has a plurality of contact sections.

8. The electrode as recited in claim 1, wherein the contact section extends along the entire width of the collector section.

9. A secondary battery cell, in particular a lithium-ion battery cell, having an electrode according to claim 1.

10. The secondary battery cell as recited in claim 9, wherein the secondary battery cell is a lithium-ion battery cell.

11. An electrically powered motor vehicle having a traction battery which has a secondary battery cell configured according to claim 9.
